(19) United States
(12) Patent Application Publication
(10) Pub. No.: US 2003/0157012 A1
(43) Pub. Date: Aug. 21, 2003

(54) Polyoxometalates and process for immobilization of technetium based thereon

(76) Inventors: Michael T. Pope, Washington, DC (US); Alexei Besserguenev, Washington, DC (US)

Correspondence Address: Pillsbury Winthrop, Intellectual Property Group, Ninth Floor East Tower, 1100 New York Avenue NW, Washington, DC, 20005-3918, US

(21) Appl. No.: 10/220,021

(22) PCT Filed: Feb. 23, 2001
(86) PCT No.: PCT/US01/05668

(51) Int. Cl. C01G 45/04

(52) U.S. Cl. 423/417; 423/2; 423/49

(57) ABSTRACT

Novel stable forms of technetium and methods for their production are provided. These methods have particular application for the removal of technetium from industrial waste compositions.

### BACKGROUND OF THE INVENTION

1. Field of the Invention

The present invention relates to new polyoxometalate compounds and nuclear waste management methods based thereon. More particularly, the polyoxometalate compounds of the present invention are useful in separating and immobilizing technetium from radioactive waste, e.g., produced during industrial or medical processes.

2. Description of the Related Art

The legacy of fifty years of nuclear processing for weapons and power production is a staggering environmental problem. In the United States alone there are more than 100 contaminated installations in 36 states and territories, and similar situations exist in other countries. The cost of cleanup using current technologies have been estimated to be in excess of $100 billion. Defense waste accounts for 95% of the volume of the total U.S. radioactive waste, but 90% of the activity is contained in spent commercial nuclear fuel. The most serious challenge in terms of environmental restoration is provided by the tank wastes at the Department of Energy (DOE) Hanford site. Most of this waste is stored in about 60 undergound tanks each holding a million gallons of alkaline slurry.

The chemical compositions of the tank wastes are highly complex and are in many cases unknown in detail, since waste streams from several fuel-processing operations were combined, together with residues from many other secondary processes. Acidic waste streams were treated with sodium hydroxide to minimize tank corrosion, making the waste highly concentrated in non-radioactive sodium salts. The tanks are known to contain significant concentrations of about 50 elements and a range of organic species (solvents and sequestrants). The radioactive elements present that are of most concern from the viewpoint of toxicity levels are Sr, Tc, Cs, U, Pu and other transuranics. Other radioactive species include Y, I, Ce, Pm and Eu. All of the components of the wastes are distributed between insoluble sludge, a high ionic strength aqueous supernatant, and a soluble salt case crystallized from the supernatant.

Three phases of processing have generally been considered for waste treatment: (a) pretreatment of raw tank waste for subsequent separations; (b) physical or chemical separations; (c) solidification (usually vitrification) of high level waste (HLW) for subsequent deep geologic storage. Although several potential processes have been described, serious difficulties and limitations remain. These include the distribution of radioactive components between the supernatant, salt cake, and sludge; the difficulties inherent in handling possible colloidal dispersions of sludge particles; and the incomplete characterization of the chemical species present. Thus, although it might be expected that lanthanide (Ln) and actinide (An) species would be present in the insoluble sludge, since the solutions are highly alkaline, the presence of organic species including sequestrants such as EDTA and nitrilotriacetic acid in some of the tanks may result in partial solubilization.

As mentioned above, Tc (technetium) is a radioactive element which is particularly toxic and often found in tank wastes from nuclear weapons development. It is estimated that 1.8 metric tons of Tc are present in tank wastes at the Hanford, Wash. site alone. Owing to the volatility and leachability of Tc (half-life of ⁹⁹Tc is approx. 200,000 yrs) removal and storage is not possible by the vitrification processes in use for all other radioactive components of nuclear waste.

Although TcO₂ has very low water solubility and a high Tc content, it can be difficult to separate from solution and is difficult to handle in dry form. The low solubility of TcO₂ in water increases dramatically in the presence of oxygen as a result of facile oxidation to the soluble TcO₄⁻ anion. At high temperatures used in vitrification procedures, TcO₂ disproportionates into metallic Tc and volatile Tc₂O₇. Prior methods for removing Tc from waste include:

Luo (U.S. Pat. No. 5,994,609) teaches a method for treating liquid hazardous waste containing anionic radioactive or heavy metal materials by binding the hazardous waste to hydroxyapatite powder; drying the hydroxyapatite powder; and cold or hot pressing the hydroxyapatite powder into a solid mass for storage or disposal.

Elfline (U.S. Pat. No. 4,764,281) teaches a method for treating radioactive metal-containing liquid by contacting the radioactive metal-containing liquid with a water-in-soluble carboxylated cellulose to separate the heavy metals from the liquid. Leitnaker et al (U.S. Pat. No. 5,885,326) teaches a method for removing technetium from iron, and other metals. This method comprises adding manganese to the technetium-contaminated metal; melting the mixture to produce a homogenous distribution of manganese and technetium; and adding sulfur to the molten homogenous mixture to precipitate manganese and technetium as a sulfide slag.

Pal et al (U.S. Pat. No. 5,994,608) teaches a method of immobilizing radioactive metals in waste which comprises mixing the waste with a reagent to produce a first mixture; adding a phosphate compound to the first mixture to produce a second mixture; and curing the second mixture to form a non-leachable solid material.

Snyder et al (U.S. Pat. No. 5,954,936) teaches a method for removing technetium complexes from liquid by adjusting the pH of the liquid to greater than 2 and directing the solution into an integrated resin and electrochemical plating device.

Saraceno et al (U.S. Pat. No. 5,826,163) teaches a method for removing technetium from uranium hexafluoride. This method involves contacting the uranium hexafluoride with a metal fluoride for a period of time sufficient for the technetium to bind to the metal fluoride. Complexes known as polyoxometalates (POMs, heteropolyanions) form a class that is of unsurpassed structural and electronic variety and versatility in inorganic and organometallic chemistry. These substances are discrete molecular-ionic species with the general formula [XₓMₘO_{y}]ⁿ⁻(m>x), where the addenda atoms, M. typically are V^{v}, Nb^{V}, Mo^{VI}, W^{VI}, and the heteroatoms, X, can be one or more of about 70 other elements in a variety of oxidation states. Salts and free acids of POM anions are water- and organic-solvent-soluble and generally have high thermal stabilities (about 500□C). The anions may contain 30 or more metal atoms, and the salts frequently have molecular weights exceeding 10,000.

POMs have many important applications: they are industrial acid-and redox catalysts (propene hydration, oxidation of methacrolein, etc.) And they find use in analytical and clinical chemistry, medicine (antiviral and antitumoral agents, electron-dense imaging agents), materials science (electronic and protonic conductors), and as selective and high-capacity oxidants and reductants. Their properties and structures are well suited to examining and modeling theories and mechanisms in areas as diverse as electron transfer, mixed valence chemistry, topology, host-guest and cryptate chemistry, self-assembly and template processes, small molecule activation, polymetallic centers in bioinorganic chemistry, cooperative magnetic behavior, surface science, heterogeneous catalysis, geology, etc.

Polyoxometalates are most commonly formed in aqueous or polar nonaqueous solutions by acid-base condensation-addition processes, e.g.,

12MoO₄²⁻+HPO₄²−+23H⁺→[Pmo₁₂O₄₀]³⁻+12H₂O

or by hydrothermal methods. The resulting anions are isolated as salts or free acids and are stable in solution over a pH range that is characteristic of the particular anion. The structures are based most often on arrangements of edge- and corner-shared MO₆ octahedra, and, for reasons of clarify, are frequently illustrated in this fashion.

Currently, more than 1000 wholly inorganic heteropolyanions of molybdenum, tungsten, and vanadium are known, but the demonstrated possibility of attaching organic and organometallic groups, or incorporating alkoxides, and of partial substitution of O²− by F⁻, O₂⁻, O₂²⁻, S²⁻, etc., extends the field considerably. As a class, POMs are remarkably stable against hydrolysis and oxidation/reduction. Although the above equation, and its analogues for other POMs, is reversible, the pH at which hydrolysis becomes significant is very much dependent upon the composition and charge of the polyanion. Some species are kinetically inert at pH 12 or higher. Since the component elements are in high oxidation states, POMs are unaffected by strong oxidants. Conversely, reduction of many kinds of POMS leads to a huge class of mixed-valence “heteropoly blues” and “-browns”, -polyanions that retain the overall molecular structures of the original oxidized species. The reduced anions show enhanced resistance to alkaline decomposition. It is this feature—an ability to absorb large numbers of electrons (up to two per metal atom) without molecular decomposition—which must partly be responsible for the stability of POMs against ionizing radiation.

Polyoxometalates have been previously used for separations of radionuclides via precipitation or complex formation. For example, the molybdophosphate anion, [PMO₁₂O₄₀]³⁻, has been used for removal of ¹³⁷Cs, either by precipitation as the tricesium salt, or by ion exchange using the insoluble ammonium or potassium salts. The success of ammonium molybdophosphate as an ion exchange material is a consequence of the zeolitic-type crystal structure observed for this and many other polyoxometalate salts, namely a lattice of large quasi-spherical polyanions interspersed with weakly-bound water molecules and countercations.

Many types of polyoxometalate complexes of lanthanides or actinides are known. Such cations demand high coordination numbers (CN=8-12) and can be incorporated into polyoxometalates in three ways: (1) as a central atom in a heteropolyanion; (2) as a complex with polyoxoanion ligands; or (3) as a cryptate.

The present inventors found that Tc compounds in the form of monovalent Tc cations bind to the surfaces of nucleophilic polyoxometalate anions to form stable, insoluble and non-volatile products. Given this ability of nucleophilic polyoxometalate anions, the present inventors developed a method of separating and concentrating technetium from tank wastes. It is known that radioactive isotopes, such as technetium, constitute less than one part in 10⁴ of the mass present in most tanks, so that if efficient separations can be devised, the total volume of HLW to be stored is reduced to more manageable quantities. Proposed separations are based on binding to inorganic polyoxometalate complexes. An enormous variety of such complexes is known, and structures can be designed to be selective for certain cations based on size and coordination preferences. In view of the high and varied salt content of tank wastes, high selectivity for the radioactive components is a major advantage. Other advantages of polyoxometalates accrue from their high stabilities in aqueous and non-aqueous media, and in the solid state, and their conversion to possible alternative waste forms for isolation and storage.

As discussed above, the isolation of technetium (⁹⁹Tc) from the environment is important since it is highly mobile in groundwater. Unfortunately, direct incorporation of Tc into glasses is impractical because it is volatilized in the vitrification process. The present inventors took advantage of the long-term stability of certain types of polyoxometalate complexes and their reduced derivatives, the heteropoly “blues” and “browns”. Heteropolyanions can be thought of as synthetic models for minerals, and control over stoichiometry and solubility is well-known. In particular, the present inventors previously elected to incorporate ⁹⁹Tc into these anions following established chemistry for rhenium. These anions are easily prepared in solution, and are easily reduced to heteropoly blues. It was theorized that reduced heteropolyanions derived materials would be attractive waste forms for Tc since they potentially would be stabilized for long term storage by the reducing environment provided by technetium's radioactive decay to stable ruthenium.

Technetium and rhenium are sufficiently similar in atomic/ionic radii and redox activity to allow Re to be potentially considered as a non-radioactive surrogate for Tc in polyoxometalate chemistry. For example, the ionic radii of Tc⁴⁺ and Re⁴⁺ are 0.77 and 0.785 A respectively, and the reduction potentials, as far as they are known, show few differences. The pertechnetate anion, TcO₄⁻, is a slightly stronger oxidant than ReO₄⁻(E□, MO₄³¹ /MO₂, +0.74 vs. 0.51 V) but both are much weaker than permanganate. In oxidic environments Re and Tc show many similarities to Mo and W: the dioxides of all four elements are essentially isostructural, as are WO₃ and ReO₃.

Also, the present inventors previously investigated the possibility that polyoxometalates incorporating Re instead of Mo or W could be synthesized. The rationale for this research was the hope that neutral polyoxometals would result by replacing enough W^{VI} atoms by Re^{VII}. Several substituted Keggin anions, containing Re^{V}O³⁺ moieties in place of W^{VI}O⁴⁺, were synthesized, [XW_{II}ReO₄₀]ⁿ⁻(X=P, Si, B), and [SiW₁₀Re₂O₄₀]⁶⁻. These stable complexes could easily be oxidized to isostructural Re^{VI} and Re^{II} analogues, and reduced to Re^{IV} and Re^{III} species. See Ortega et al, Inorg. Chem. 23:3292 (1984). More recently, Abrams et al (Inorg. Chim. Acta. 180.9 (1991)) have reported analogous Tc derivatives, [PW₁₁TcO₄₀]⁴⁻, [SiW₁₁TcO₄₀]⁵⁻, and [PW₁₁TcNO₃₉]⁴⁻. Oxidation of the first of these complexes to the Tc^{VI} derivative is reported to occur at +0.84 V (vs. Ag/AgCl; acetonitrile solution); the corresponding potential for the Re complex is +0.13 V.

A specific example of a previously reported method for synthesizing polyoxometalates containing rhenium comprises complexes analogous to those described above in which ReO³⁺has replaced one or more WO⁴⁺or MoO⁴⁺groups. It is striking that the 6-coordinate ionic radii of Re⁵⁺ and W⁶⁺ are identical (0.74 A). The general procedure for such syntheses is the reaction of appropriate lacunary anions or other precursor species with ReO₄₋ and a reducing agent such as I^{- or Sn}^{II}. Such a procedure (MO₄⁻ plus reductant) is routinely used for the synthesis of complexes with TcO³⁺ cores for radiopharmaceutical applications. An alternative convenient source of Re (Tc) is MCl₆²⁻. In addition to the lacunary anions that were used in previous work, several other heteropoly species have been investigated. These include more highly-charged monovacant lacunary anions such as [P₂W₁₇O₆₁]¹⁰⁻; divacant species γ-[SiW₁₀O₃₆]⁸⁻ (Canny et al, Inorg. Chem. 25:2114 (1991); Teze et al, Inorg. Synth. 27:85 (1990); Canny et al, Inorg. Chem. 30:976 (1991); Zhang et al, Inorg. Chem. 35:30 (1996)), and anion 10 (which is both a cryptand and a lacunary anion with binding sites for two metal cations (or oxocations) in addition to the encrypted central atom); and trivacant species such as A—[SiW₉O₃₄]¹⁰⁻(Herve et al, Inorg. Chem. 16:2115 (1977)); B—[X^{III}W₉O_{33]}⁹⁻(X=As, Sb) (Tourne et al, Hebd. Seances Acad. Sci., Ser. C, 277:643 (1973) and Jeannin et al, J. Am. Chem. Soc. 103:1664 (1981)); and [P₂W₁₅O₅₆]¹²⁻ (Contant et al, J. Inorg. Nucl. Chem. 43:1525 (1981) and Contant, Inorg. Synth. 27:108 (1990)). Synthesis of the starting lacunary anions is a straightforward procedure to one of skilled in the art.

A second previously reported method for incorporation of Re (Tc) in polyoxometalates is to target heteropoly derivatives of Re starting with simple tungstate or molybdate anions and Re species. For example, salts of [ReCl₆]²⁻ are isostructural with those of [PtCl₆]²⁻. Numerous examples of “Anderson”-type heteropolyanions of Pt^{IV}, [PtM₆O₂₄]³⁻(M=Mo, W) have been prepared (Lee et al, Acta Crystallogr, Sec. C 40:5 (1984); Lee et al, Chem. Lett. 1297 (1984)). The present inventors have recently been investigating polyoxotungstate complexes with lanthanides and actinides in connection with possible applications in the sequestration and immobilization of these species in nuclear wastes. Although polytungstates are thermally stable and radiation-resistant, their instability in highly alkaline solutions renders them inappropriate for certain waste streams, e.g. alkaline tank wastes. In contrast polyoxoanions of niobium and tantalum are stable only in basic media (pH>10).

What is needed in the art are novel polyoxometalates and methods of immobilizing technetium which overcome the problems associated with existing methods. Namely, a method is required that results in the production of a form of technetium that is stable and which is easily recovered from a material such as nuclear waste, facilitating its separation or removal therefrom. The present invention provides such polyoxometalates and process.

### SUMMARY OF THE INVENTION

An object of the present invention is to provide novel tricarbonyl metal derivatives of hexametalate anion or salts thereof which serve as surrogates for technetium radioactive cations. The derivatives are of the formula [M₆O₁₉{M′(CO)₃}ₙ]⁽⁸⁻ⁿ⁾⁻, wherein M is Nb or Ta, M′ is Mn or Re and n is 1, 2, 3 or 4. Preferred tricarbonyl metal derivatives include tricarbonyl derivative is selected from the group consisting of:

[Re(CO)₃Nb₆O₁₉]⁷⁻; [Re(CO)₃Ta₆O₁₉]⁷⁻; [Mn(CO)₃Ta₆O₁₉]⁷⁻; [Mn(CO)₃Nb₆O₁₉]⁷⁻; trans-[{Mn(CO)₃}₂Nb₆O ₁₉]⁶⁻; cis-[{Mn(CO)₃}₂Nb₆O₁₉]⁶⁻; trans-[{Mn(CO)₃}₂Ta₆O₁₉]⁶⁻; cis-[{Mn(CO)₃}₂Ta₆O₁₉]⁶⁻; cis-[{Re(CO)₃}₂Nb₆O₁₉]⁶⁻; trans-[{Re(CO)₃}₂Nb₆O₁₉]⁶⁻; trans-[{Re(CO)₃}₂Ta₆O₁₉]⁶⁻; cis-[{Re(CO)₃}₂Ta₆O₁₉]⁶⁻.

Another object of the invention is to provide a method for immobilizing technetium (Tc) which comprises binding Tc cations to a nucleophilic polyoxometalate anion, wherein Tc is stabilized by pi-acceptor through ion exchange of Re or Mn, initially present in the polyoxometalate anion.

Another object of the present invention is to provide a method for immobilizing technetium (Tc) which comprises binding Tc cations, stabilized by pi=acceptor ligands, to highly nucleophilic polyoxometalate anions.

A more specific object of the invention is to provide Tc compounds in the form of monovalent Tc cations that bind to nucleophilic polyoxometalate anions to form stable, insoluble, non-volatile products. Another specific object of the invention is to provide a novel method for removal of technetium (Tc) from industrial compositions, in particular nuclear waste compositions, by binding positively charged (Tc(I) cations, stabilized with appropriate pi-acceptor ligands (e.g., CO and isonitriles) to nucleophilic polyoxymetalate anions and removing the resultant insoluble form of technetium, which is immobilized to a polyoxyanion derivative.

Still another object of the invention is to provide novel storage stable forms of technetium, i.e., insoluble salts comprising technetium and polyoxoanions or polyoxyanion polymers.

### BRIEF DESCRIPTION OF THE DRAWINGS

FIG. 1. Oxygen-17 NMR spectra of (a) MnTa₆, (b) MnNb₆, (c) ReTa₆, and (d) ReNb₆

FIG. 2. Oxygen-17 NMR spectra of trans isomers of (a) Re₂Nb₆, (b) Mn₂Nb₆, and (c) Re₂Ta₆

FIG. 3. Oxygen-17 NMR spectra of cis isomers of (a) Re₂Nb₆, (b) Mn₂Nb₆, and (c) Mn₂Ta₆

FIG. 4. The structure of trans-[Nb₆O₁₉{Re(CO)₃}₂]⁶⁻in (a) polyhedral, and (b) thermal-ellipsoid (50 %) representations.

FIG. 5. The structure of cis-[Nb₆O₁₉{Re(CO)₃}₂]⁶⁻in (a) polyhedral, and (b) thermal-ellipsoid (50 %) representations.

FIG. 6. Infrared spectra of Nb₆, ReNb₆, t-Re₂Nb₆, and c-Re₂Nb₆

FIG. 7. TGA curves of t-Mn₂Ta₆ (Mn) and t-Re₂Nb₆ (Re)

### DESCRIPTION OF THE PREFERRED EMBODIMENTS

The term “anion” or “anionic” refers to any negatively charged ion, for example, MnO₄³¹ or TcO₄⁻.

“Cation” refers to any positively charged ion.

The term “Curie (Ci)” refers to the unit of radioactivity equal to 3.7 ×10¹⁰ disintegrations per second or 3.7 ×10¹⁰ becquerel (Bq). A common unit used in environmental measurements is the picocurie (pCi) which is equal to 1/10⁻¹² Ci or 0.037 disintegrations per second or 0.037 Bq.

The term “half-life” is used to mean the time it takes for half of a radioactive material to radiate energetic particles and rays and transform to new materials. For example, cesium (Cs¹³⁷) has a half life of thirty years. After this time, half of the Cs¹³⁷ decays to a non-radioactive stable nuclide, barium (Ba-137). The term “hazardous waste” refers to any solid wastes that pose substantial or potential threats to public health or the environment including any waste that meets the criteria specified in 40 CFR 260 and 261: (a) is specifically listed as a hazardous waste by EPA; (b) exhibits one or more of the characteristics of hazardous waste (ignitability, corrosivity, reactivity, and/or toxicity); (c) is generated by the treatment of hazardous waste; or is contained in a hazardous waste.

“High Level Radioactive Waste (HLW)” refers to radioactive waste material that results from the reprocessing of spent nuclear fuel, including liquid waste produced directly from reprocessing and any solid waste derived from the liquid that contains a combination of transuranic and fission product nuclides in quantities that require permanent isolation. HLW is also a mixed waste because it has highly corrosive components or has organics or heavy metals that are regulated under RCRA. HLW may include other highly radioactive material that NRC, consistent with existing law, determines by rule requires permanent isolation

The term “solid waste” refers to any solid, semi-solid, liquid, or contained gaseous materials discarded from industrial, commercial, mining, or agricultural operations, and from community activities. Solid waste includes garbage, construction debris, commercial refuse, sludge from water supply or waste treatment plants, or air pollution control facilities, and other discarded materials. Solid waste does not include solid or dissolved materials in irrigation return flows or industrial discharges which are point sources subject to permits under section 402 of the Clean Water Act or source, special nuclear, or byproduct material defined by the AEA.

The term “vitrification” refers to the process of converting materials into a glass-like substance, typically through a thermal process. Radionuclides and other inorganics are chemically bonded in the glass matrix. Consequently vitrified materials generally perform very well in leach tests. EPA has specified, under the land disposal restrictions, vitrification to be the treatment technology for high-level waste.

As discussed previously, initial investigations were carried out with rhenium as a Tc-surrogate to ascertain whether such methods would result in rhenium polyoxyanion compounds having desirable properties providing for their separation. For example, Tungstorhenates incorporating Re(V) and Re(IV) have been characterized. However, polyniobates and niobotungstates offer the advantages of stability in alkaline solutions which constitute the majority of tank wastes. The first example of a nioborhenate (IV) complex, [Re(Nb₆O₁₉)₂]¹²⁻, has been isolated from alkaline solution but has proved difficult to crystallize for structural confirmation. Furthermore, Re is slowly oxidized and released from this material. A much more promising strategy has recently been discovered by the present inventors. Specifically, the discovery of the present invention is that positively charged Tc(I) cations can be stabilized by appropriate pi-acceptor ligands such as CO or isonitriles (RNC) which stably bind to nucleophilic polyoxometalate anions. Moreover, and advantageously, it has been found that the resultant complexes are highly stable in different thermal, hydrolytic and oxidizable environments. Also, it has been discovered that these reactions can be effected in aqueous solutions under hydrothermal conditions, e.g., about 130° C. in a closed container.

More specifically, it has been found that alkaline (pH ˜12) aqueous solutions of Nb₆O₁₉⁸⁻ react with Re(I) carbonyl complexes under hydrothermal conditions to form [Nb₆O₁₉Re(CO)₃]⁷⁻ and [Nb₆O₁₉{Re(CO)₃}₂]⁶⁻(syn and anti isomers). These novel complexes have been characterized by ¹⁷O NMR spectroscopy and single crystal X-ray structural analysis. The solid salts are thermally stable to 400° C. (loss of CO, not Re) and are inert to oxidation.

According to the invention, a typical reaction involving Tc is:

[Nb₆O₁₉]⁸+2Tc(CO)₅Br→[Nb₈O₁₉{Tc(CO)₃}₂]⁶⁻(1)+2Br⁻+4CO

The invention is applicable using different technetium starting materials. For example, other technetium compounds which can be used as starting materials (synthons) for such reactions include, e.g., [Tc(CO)₃(H₂O)₃]⁺, [Tc(NCR)₆]⁺, and (C₅Me₅)Tc(CO)₃. Methods for synthesis of such compounds are well known For example, simple, efficient methods of synthesis of the latter compounds from TcO₄⁻ have been developed in the context of nuclear medicine (use of ^{99m}Tc, an isotope with a 6-hour half-life, for organ imaging). The formation of a compound such as (1) above is favored by the electrostatic attraction between the Tc(I) cation (e.g. [Tc(CO)₃(H₂O)₃]⁺) and the negatively charged oxygens on the surface of the polyoxoanion (e.g. [Nb₆O₁₉]⁸⁻). However, the final product (1) contains Tc covalently attached to the polyanion through three strong Tc—O bonds and is extremely stable.

Other polyoxometalate anions containing other early transition elements such as Nb(V), Ta(V), Mo(VI), W(VI), W(IV), Ti(IV) and Zr(IV), or combinations of these elements can be used. The resulting compounds may be discrete polyoxoanion derivatives (such as (I)) which may be isolated and stored as insoluble salts, or the starting polyoxoanion itself may be an insoluble polymeric material (an example is [KMo₅O₁₆H(H₂(H₂O)]□). In such cases, the Tc atoms will become covalently attached to the polymer and remain permanently immobilized.

Given that the subject invention provides stable, insoluble technetium compounds, the invention is particularly well suited for removal of technetium ions, e.g., nuclear waste materials. Essentially, such methods will comprise treating said waste under the above-described alkaline conditions to provide insoluble technetium salts which are then recovered and stored. As noted, these salts are stable at high temperature (stable up to 400° C.) and inert to oxidation. Thus, the present invention provides complexes which should be excellent materials for separation and storage of technetium from nuclear waste. Also, the fact that they are stable under alkaline conditions is a particular advantage as this corresponds to conditions of the majority of nuclear tank washes.

The new niobate and tantalate derivatives reported here are easily prepared in good yield in aqueous solution starting with [M(CO)₃(CH₃CN)₃]⁺ or under hydrothermal conditions with [M(CO)₅Br]. The compositions and structures of the new complexes are established by elemental analysis, infrared and oxygen-17 NMR spectroscopy, and by single crystal X-ray diffraction of five salts.

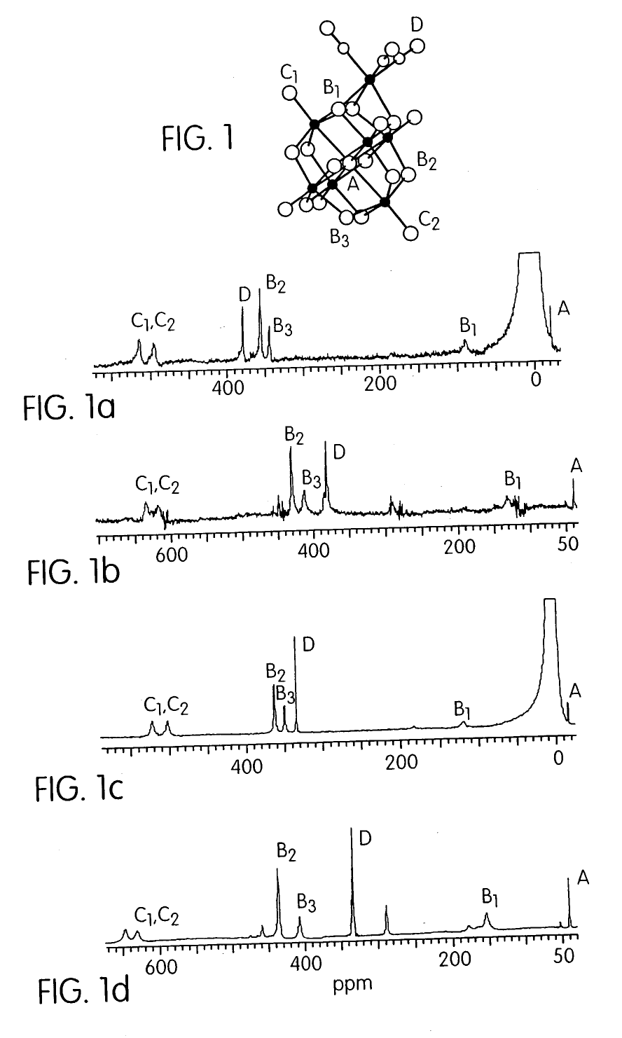

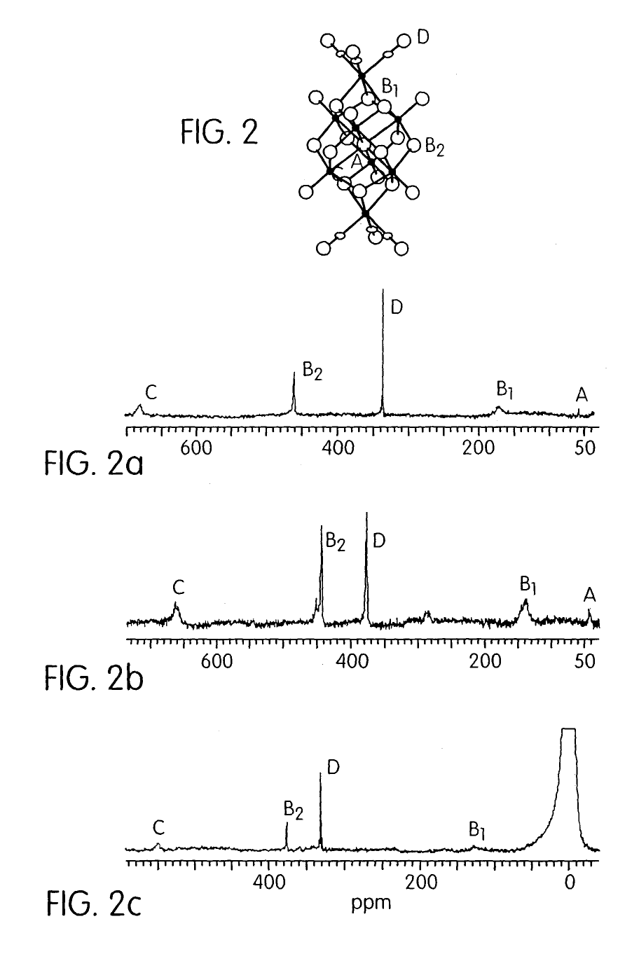

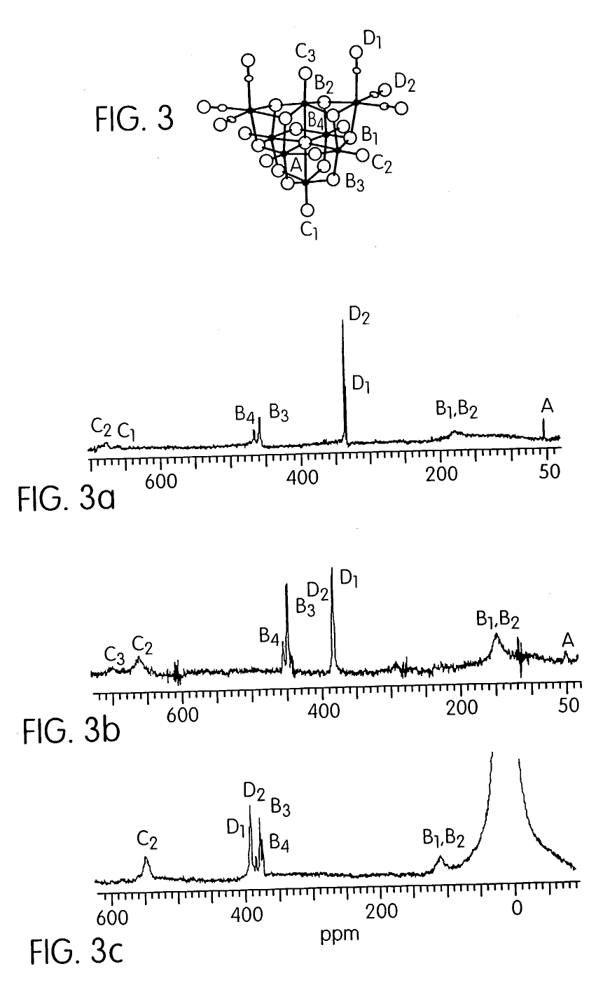

Oxygen-17 NMR spectroscopy proved to be the simplest way to confirm the structures of the product anions, see FIGS. 1-3, and Table 1. The salts were soluble enough to allow accumulation of spectra of unenriched samples within 20 h. All symmetry-distinct oxygen atoms could be detected and assignments are shown in the Figures. All assignments were made on the basis of peak intensities and proximity of peaks to corresponding peaks of Nb₆ and Ta₆. Some spectra revealed the presence of ClO₄−(δ˜290 ppm) as an impurity, and spectra of enriched samples of ReNb₆ showed signals from traces of c- and t-Re₂Nb₆ The formation of 2:1 complexes and the existence of both cis and trans isomers was first deduced from the NMR spectra.

TABLE 1
Oxygen-17 NMR Chemical Shifts

| Compound | Terminal | Bridging | Central | Carbonyl |
|---|---|---|---|---|
| Nb₆ | 600 | 395 | 26 | — |
| Ta₆ | 483 | 331 | −34 | — |
| MnNb₆ | 615, 633 | 128, 410, 428 | 35 | 378 |
| ReNb₆ | 629, 645 | 156, 408, 435 | 40 | 333 |
| MnTa₆ | 497, 516 | 91, 346, 357 | −21 | 380 |
| ReTa₆ | 502, 521 | 121, 349, 361 | −17 | 334 |
| c-Mn₂Nb₆ | ?^{a}, 659, 697 | 145, ?, 447, 454 | 47 | 382, 383 |
| c-Re₂Nb₆ | 659, 675, 719 | 178, 190, 457, 465 | 54 | 334, 336 |
| c-Mn₂Ta₆ | ?, 541, ? | 103, ?, 367, 371 | ? | 384, 386 |
| t-Mn₂Nb₆ | 663 | 143, 447 | 46 | 382 |
| t-Re₂Nb₆ | 679 | 169, 458 | 53 | 335 |
| t-Re₂Ta₆ | 553 | 133, 379 | ? | 336 |

Signal not reliably observed

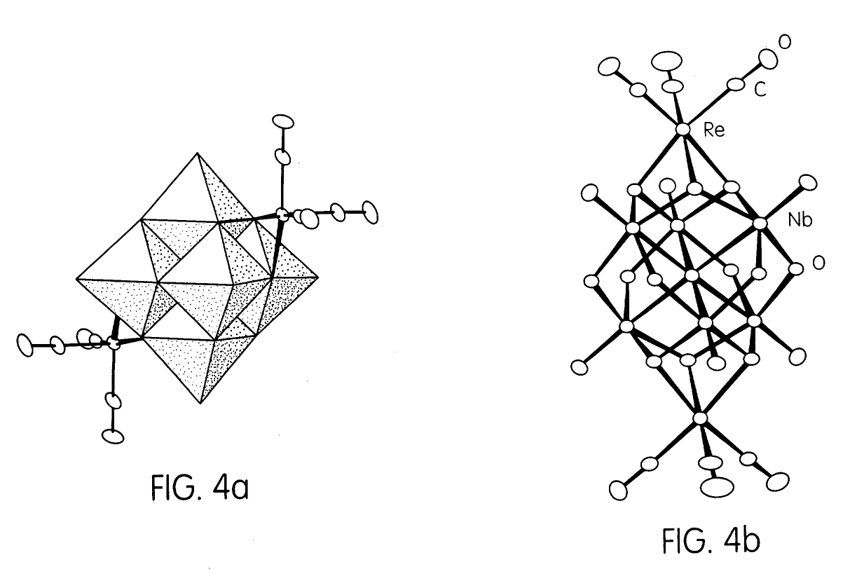

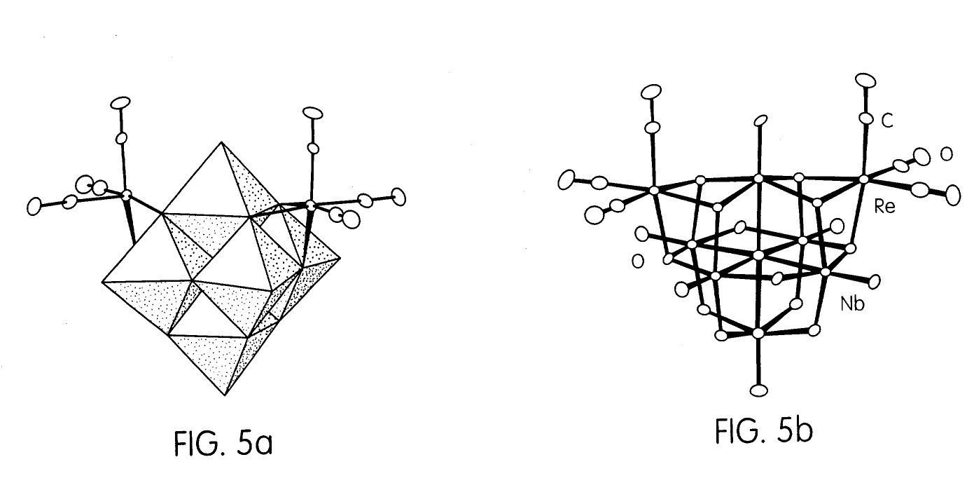

X-ray analysis of single crystals of potassium salts of trans isomers of Re₂Nb₆, Mn₂Nb₆, and Re₂Ta₆ and of cis isomers of Mn₂Nb₆ and Re₂Nb₆ are summarized in Tables 2 and 3. The structures of trans- and cis-isomers are shown in polyhedral and thermal-ellipsoid representations in FIGS. 4 and 5. The metrical data listed in Table 3 are for the most part unexceptional. Attachment of [M(CO)₃]⁺ to the anions results in a “closing up” of the three surface oxygen atoms involved. The non-bonded O—O contacts are ˜0.2 Å shorter than those in corresponding O₃ sets that are not bonded to M (2.777-2.851). This presumably reflects the reduction in charge density on the bonded oxygen atoms. At the same time the O—M—O angles are reduced from an idealized 90° to 75-80°, a distortion dictated by the lengths of the M—O bonds.

TABLE 3
Selected average bond-lengths (Å) and -angles (°).
M = Nb, Ta; M′ = Mn, Re

| | t-Re₂Nb₆ | t-Mn₂Nb₆ | t-Re₂Ta₆ | c-Re₂Nb₆ | c-Mn₂Nb₆ |
|---|---|---|---|---|---|
| M- | 1.765(5) | 1.776(5) | 1.79(2) | 1.765(6) | 1.771(5) |
| O(terminal) | | | | | |
| M-O(M) | 1.964(4) | 1.971(4) | 1.96(1) | 1.920(6)- | 1.931(1)- |
| | | | | 2.010(6) | 2.004(4) |
| M-O(M,M′) | 2.048(4) | 2.044(4) | 2.06(1) | 2.017(6)- | 2.003(4)- |
| | | | | 2.092(6) | 2.066(4) |
| M-O(M₅) | 2.3972(6) | 2.3967(6) | 2.397(1) | 2.397(6) | 2.386(4) |
| M′-C | 1.894(7) | 1.804(8) | 1.88(3) | 1.904(9) | 1.793(8) |
| M′-O(M₂) | 2.176(5) | 2.085(5) | 2.17(2) | 2.178(6) | 2.070(5) |
| CM′C | 88.6(4) | 88.8(4) | 90(1) | 89.4(4) | 88.9(3) |
| OM′O | 74.8(2) | 79.2(2) | 75.6(7) | 74.9(2) | 79.0(2) |

The cis isomers of the 2:1 complexes have two open O₃ sets that could be used for attachment of additional M(CO)₃ groups. All four such positions are occupied in the neutral species [{(C₅Me₅)Rh}₄V₆O₁₉]. Attempts to introduce more than two M(CO)₃ groups to the niobate and tantalate systems have so far been unsuccessful.

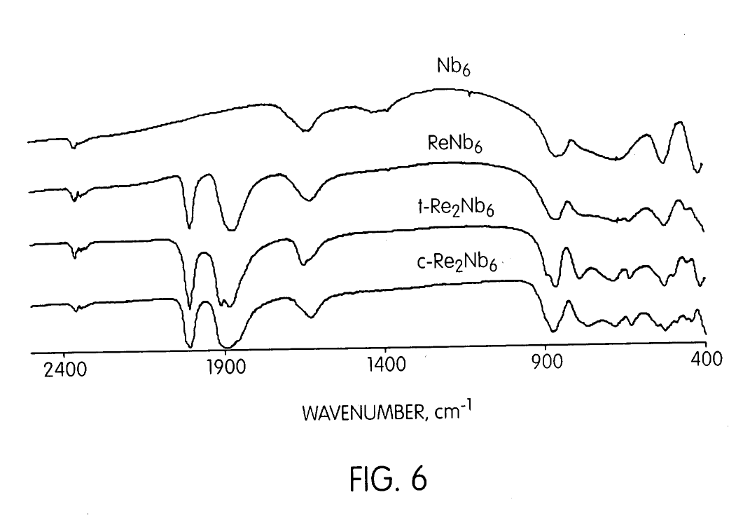

Representative infrared spectra are shown in FIG. 6 and these provide the quickest way to identify the three structural types. Vibrational frequencies for all the new complexes are listed in the Supporting Information, The simple metal-oxygen stretching pattern (400-900 cm⁻¹) of the original hexametalate anions¹⁶ is split into more components by the lower symmetry of the M(CO)₃ derivatives, and a new weak band at ˜460 cm⁻¹ is assigned to the Mn(Re)—C vibrations.^{10b} In addition two sets of CO stretching bands are seen at ca 1900 and 2000 cm⁻¹. Similar bands are observed for a number of fac-[M(CO)₃L₃]⁺, M=Mn, Re complexes.

Unlike the underivatized hexametalates, which are stable only in strongly basic media (precipitation of the oxides begins below pH ˜10, solutions of the Mn and Re derivatives show no sign of precipitation when the pH is lowered to 4. Cyclic voltammograms of all the compounds in 0.1 M sodium acetate show no redox features except an irreversible oxidation process at +1.5 V (Re) and +0.9 V (Mn). Similar features are observed in voltammograms of the corresponding [M(CO)₃(CH₃CN)₃]⁺ +cations.

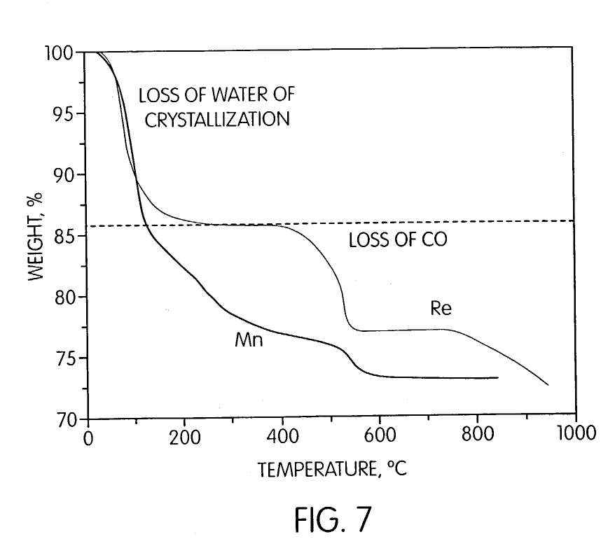

Representative TGA curves for t-Mn₂Nb₆ and t-Re₂Nb₆ are shown in FIG. 7. The other complexes behave similarly. The initial weight loss corresponds to the loss of water of crystallization. A second endothermic process starts at 400-450□C for the Re compounds and at ˜200° C. for the Mn compounds, and corresponds to the loss of the CO ligands. A third weight loss (Re compounds only) above 700° C. is assumed to be associated with the loss of Re₂O₇ formed by oxidation or disproportionation.

### EXAMPLES

Syntheses.

Potassium hexaniobate, K₇HNb₆O₁₉13H₂O (Nb₆) and potassium hexatantalate, K₈Ta₆O₁₉17H₂O (Ta₆) were prepared by literature methods and characterized by infrared spectroscopy and ¹⁷O-NMR spectroscopy. Nb₆ IR, cm⁻¹: 856 (vs), 777 (s); 669 (s); 528 (s); 418 (vs); ¹⁷O-NMR, ppm: 26 (O(M₆); A); 395 (O(M₂); B); 600 (O(M); C); Ta₆ IR, cm⁻¹: 854 (s), 837 (s), 700 (s), 536 (s); ¹⁷O-NMR, ppm: ˜34 (O(M₆); A); 331 (O(M₂); B); 483 (O(M); C). Sodium salt of Nb₆ was obtained from a solution of the potassium salt by precipitation with 5 M NaCl. Dirhenium decacarbonyl, Re₂(CO)₁₀, and pentacarbonylbromomanganese, Mn(CO)₅Br, were purchased from Aldrich and used without further purification. Pentacarbonylbromorhenium, Re(CO)₅Br, triscarbonyltrisacetonitrilerhenium perchlorate, [Re(CO)₃(CH₃CN)₃]CIO₄ and triscarbonyltrisacetonitrilemanganese perchlorate, [Mn(CO)₃(CH₃CN)_{3]CIO}₄ were prepared by literature methods¹⁰ and characterized by infrared spectroscopy and ¹⁷O NMR spectroscopy. Re(CO)₅Br IR, cm⁻¹: 2151 (m); 2059 (vs), 2035 (vs); 1974 (vs), 1964 (vs); 1122 (m); 1109 (w); 1004 (vw); 939 (vw); 912 (vw); 588 (vs); 553 (m); ¹⁷O-NMR (CD₃CN), ppm: 357(sh), 356; 338 (CO), [Re(CO)₃(CH₃CN)₃]CIO₄ IR,cm⁻¹2364 (w), 2327 (w), 2298 (w), 2045 (vs), 1934 (vs), 1419 (w), 1369 (w), 1143 (sh), 1091 (vs), 1035 (w), 910 (w), 648 (sh), 625 (s), 588 (m), 540 (w), 482 (w); ¹⁷O-NMR (CD₃CN), ppm: 342 (CO), [Mn(CO)₃(CH₃CN)₃]CIO₄ IR, cm⁻¹: 2364 (w), 2327 (w), 2300 (w), 2057 (vs),1959 (vs), 1423 (w), 1373 (w), 1093 (vs), 1037 (m), 681 (m), 625 (s), 528 (m), 457 (m); ¹⁷O-NMR (CD₃CN), ppm: 389 (CO).

### Example I

K₇[Re(CO)₃Nb₆O₁₉] (ReNb₆). Deionized water was used throughout all syntheses. One mmol (0.4067 g) Re(CO)₅ Br was added to a solution of 1.37 g (1 mmol) Nb₆ in 2 mL water contained in a teflon-lined Parr acid digestion bomb, the bomb was sealed and the mixture was heated to 130° C. for 17 hours. Upon cooling the resulting mixture, about 10 mg of insoluble unreacted Re(CO)₅Br was filtered off and addition of 15 mL ethanol to the filtrate (V_{adjusted}=5 mL) yielded 1.19 g (71 %) of crude product. The impurity, about 10 % of trans-K₆[{Re(CO)₃}₂Nb₆O₁₉] (t-Re₂Nb₆) was removed by dissolving the solid in 2.5 mL of water and adding 3 mL 5M NaCl to precipitate pure ReNb₆. Anal. Obs. (Calc. for Na₇[Re(CO)₃Nb₆O₁₉].9H₂O): Na, 12.1 (11.06); Re, 12.7 (12.8); Nb, 37.3); C, 2.52 (2.47).

### Example II

K₇[Re(CO)₃Ta₆O₁₉] (ReTa₆). One-half mmol (0.1809 g) [Re(CO)₃(CH₃CN)₃]CIO₄ was dissolved into a solution of 1.0038 g (0.5 mmol) Ta₆ in 10 mL of water, which had previously been deaerated with a stream of N₂ for 20 min. The reaction mixture, in a 100-mL single-necked flask fitted with a reflux condenser, was heated to 60° C. under a positive pressure of N₂ for 2.5 h. Upon cooling 60 mg of white insoluble material was filtered off, and addition of 15 mL ethanol to the filtrate (V_{adjusted}=15 mL) yielded 0.70 g (64 %) product. Anal. Obs. (calc. for K₇[Re(CO)₃Ta₆O₁₉].9H₂O): K, 12.7 (13.1); Re, 9.10 (8.90); Ta, 50.2 (51.8); C, 2.10 (1.72).

### Example III

K₇[Mn(CO)₃Ta₆O₁₉] (MnTa₆). The procedure for ReTa₆ was repeated using [Mn(CO)₃(CH₃CN)₃]CIO₄. After heating, 20 mg insoluble material was filtered off and the yellow product (0.57 g, 55%) was recovered from the filtrate (V_{adjusted}=¹⁵ mL) by precipitation with 15 mL ethanol. Anal. Obs. (calc. for K₇[Mn(CO)₃Ta₆O₁₉].15H₂O): K, 13.22 (13.21); Mn, 2.67 (2.65); C, 1.76 (1.74); Ta, 52.30 (52.39).

### Example IV

K₇[Mn(CO)₃Nb₆O₁₉] (MnNb₆). The procedure for ReTa₆ was repeated using [Mn(CO)₃(CH₃CN)₃]CIO₄ and Na₇HNb₆O₁₉15H₂O. After heating the reaction mixture (V=40 mL) at 90° C. for 3 h., a small amount of insoluble material was filtered off, and the volume of the filtrate was reduced to 15 mL on a rotary evaporator. The yellow product (1.00 g, 70 %) was obtained by precipitation with 15 mL ethanol. Anal. Obs. (calc. for K₇[Mn(CO)₃Nb₆O₁₉].12H₂O): K, 17.51 (17.79); Mn, 3.25 (3.57); C, 2.30 (2.34); Nb, 37.24 (36.24).

### Example V

trans/cis-K6[{Mn(CO)₃}₂Nb₆O₁₉](t/c-Mn₂Nb₆). The procedure for ReTa₆ was repeated using two mmol (0.72 g) of [Mn(CO)₃(CH₃CN)₃]CIO₄ and one mmol (1.37 g) of K₇HNb₆O₁₉13H₂O. After stirring the reaction mixture (V=40 mL) at room temperature for 4.5 h, a small amount of insoluble material was filtered off. The volume of the filtrate was reduced to 20 mL using a rotary evaporator, and 20 mL ethanol was added to the filtrate to produce a yellow precipitate (0.48 g, 29%, 75% t-Mn₂Nb₆, 25% c-Mn₂Nb₆). The resulting filtrate, still yellow, was evaporated to 5 mL, and pale yellow material (KClO₄) was filtered off. c-Mn₂Nb₆ (0.43 g, 25 %) was precipitated with 7 mL ethanol.

The relative amounts of trans vs. cis isomers are influenced by synthesis temperature. When previously described procedure was repeated by refluxing the reaction mixture at 80° C. for 3 h, first precipitation with ethanol afforded 0.89 g of yellow product (51%; 25% t-Mn₂Nb₆, 75% c-Mn₂Nb₆).

Crystals suitable for x-ray study were grown by a combination of slow cooling and slow ethanol vapor diffusion into an aqueous solution. Four hundred eighty milligrams of t-Mn₂Nb₆ was dissolved in 2.5 mL of water. Two types of crystals appeared after 2-3 weeks of storage in a refrigerator at 7□C. Small yellow crystals of t-Mn₂Nb₆ (0.17 g) formed. In addition, 0.06 g of large yellow needle type crystals of c-Mn₂Nb₆ was recovered. Anal. Obs. (calc. for K₆[{Mn(CO)₃}₂Nb₆O₁₉].8H₂O): K, 15.60(15.46); Mn, 7.20 (7.24); C, 5.10 (4.74); Nb, 36.2 (36.7). Four hundred thirty milligrams of c-Mn₂Nb₆ was dissolved in 2.5 mL of water. Large needle type yellow crystals of c-Mn₂Nb₆ (0.16 g) formed after 2-3 weeks of storage in a refrigerator at 7□C. Anal. Obs. (calc. for K₆[{Mn(CO)₃}₂Nb₆O₁₉].23H₂O): K, 13.30 (13.12); Mn, 6.25 (6.15); C, 4.15 (4.03); Nb, 29.9 (31.2).

### Example VII

cis-K6[{Mn(CO)₃}₂Ta₆O₁₉] (c-Mn₂Ta₆). The procedure for ReTa₆ was repeated using 0.56 mmol (0.2006 g) of [Mn(CO)₃(CH₃CN)₃]CIO₄ and 0.56 mmol (1.15 g) of MnTa₆. Several drops of 3M KOH were added to adjust the pH of water to 11 before dissolving MnTa₆. After refluxing the reaction mixture (V=10 mL) at 100° C. for 2 h, about 60 mg of insoluble material was filtered off, and the yellow product (0.60 g, 49%) was recovered from the filtrate (V_{adjusted}=10 mL) by precipitation with 15 mL ethanol. Anal. Obs. (calc. for K₆[{Mn(CO)₃}₂Ta₆O₁₉]□16H₂O): K, 10.52 (10.71); Mn, 5.21 (5.02); C, 3.22 (3.29); Ta, 48.4 (49.6).

### Example VIII

trans/cis-K₆[{Re(CO)₃}₂Nb₆O₁₉] (t/c-Re₂Nb₆). The procedure for ReNb₆ was repeated using one mmol (1.37 g ) of Nb₆ and two mmol (0.82 g ) of Re(CO)₅Br. After cooling the resulting mixture 0.84 g (44 %) of a white precipitate (mostly t-Re₂Nb₆ with impurity of unreacted Re(CO)₅Br) was recovered. t-Re₂Nb₆ was purified by dissolving in 2 mL of water, filtering off 10 mg of unreacted Re(CO)₅Br, and precipitating t-Re₂Nb₆ with ethanol. To the filtrate left from hydrothermal synthesis 5 mL of ethanol was added producing 0.49 g (25 %) of white precipitate (˜75% c-Re₂Nb₆, ˜25% t-Re₂Nb₆).

Crystals suitable for x-ray study were obtained similarly to the manganese compounds. Eight hundred ten milligrams of t-Re₂Nb₆ was dissolved in 5 mL of water. Seven hundred twenty milligrams of colorless block crystals of t-Re₂Nb₆ were recovered after storage in a refrigerator for 8 weeks at 7° C. Anal. Obs. (calc. for K₆[{Re(CO)₃}₂Nb₆O₁₉].15H₂O): K, 12.42 (12.31); Re, 19.55 (19.5); C, 3.81 (3.78); Nb, 29.23 (29.24). Six hundred twenty milligrams of c-Re₂Nb₆ was dissolved in 3 mL of water. Three hundred forty milligrams of large colorless needle crystals of c-Re₂Nb₆ was recovered after refrigerating for 6-8 weeks at 7□C. Anal. Obs. (calc. for K₆[{Re(CO)₃}₂Nb₆O₁₉].19H₂O): K, 11.83 (11.86); Re, 18.72 (18.82); C, 3.62 (3.64); Nb, 28.11 (28.18).

An alternative procedure for trans-K6[{Re(CO)₃}₂Nb₆O₁₉] (t-Re₂Nb₆). The procedure for ReTa₆ was repeated using one mmol (1.37 g) of Nb₆ and two mmol (0.99 g) of [Re(CO)₃(CH₃CN)₃]CIO₄. After heating the reaction mixture (V=40 mL) at 60□C for 1.5 h., a small amount of insoluble material was filtered off. The volume of the filtrate was reduced to 20 mL using a rotary evaporator, and 0.95 g (50 %) of white t-Re₂Nb₆ was recovered after precipitation with 20 mL ethanol.

### Example XI

trans-K4Na2[{Re(CO)₃}₂Ta₆O₁₉] (t-Re₂Ta₆). The procedure for c-Mn₂Ta₆ was repeated using 0.32 mmol (0.71 g) of potassium salt of ReTa₆ and 0.32 mmol (0.1591 g) of [Re(CO)₃(CH₃CN)₃]CIO₄. Several drops of 3 M NaOH were added to adjust pH of water >10 before dissolving ReTa₆. After refluxing the reaction mixture (V=12 mL) at 100□C for 1 h, 0.53 g (68 %) of white t-Re₂Ta₆ was recovered by precipitation with 12 mL ethanol. Single crystals were grown using the same procedure as for t-Mn₂Nb₆ and t-Re₂Nb₆. Anal. Obs. (calc. for K₄Na₂[{Re(CO)₃}₂Ta₆O₁₉]□11H₂O): K, 7.31 (6.71); Na, 1.98 (1.97); Re, 15.7 (16.0); C, 3.23 (3.09); Ta, 45.32 (46.58). ¹⁷O enrichment.

### Example X

The procedure for synthesis of ReNb₆, t/c-Re₂Nb₆ was followed using instead of deionized water a mixture of 1.5 mL of 99% D₂O and 1.0 g of 10% enriched water for ReNb₆ enrichment and a mixture of 2.5 mL of 99% D₂O and 0.53 g of 10% enriched water for t/c-Re₂Nb₆ enrichment.

Instrumental.

An approximate sphere of data was collected on a Siemens SMART 1K CCD system. Crystal stability was monitored by recollection of the first fifty frames after data collection was finished. No significant decay was observed. Crystallographic data are in Table 2. The structures were solved by direct methods using SHELXTL. Hydrogen at were not included in the model.

TABLE 2
Crystal data.

| | t-Re₂Ta₆, 1 | t-Re₂Nb₆, 2 | t-Mn₂Nb₆, 3 | c-Mn₂Nb₆, 4 | c-Re₂Nb₆, 5 |
|---|---|---|---|---|---|
| Empirical | K4 Na2 Re2 C6 Ta6 | K6 Re2 C6 Nb6 O38 | K6 Mn2 C6 Nb6 | K6 Mn2 C6 Nb6 O50 | K6 Re2 C6 Nb6 O54 |
| Formula weight | 2312.70 | 1870.76 | 1590.19 | 1824.40 | 2158.98 |
| Space group | C2/m (No.) | C2/m (No. 12) | C2/m (No. 12) | P1 (No. 2) | P2₁/c (No. 14) |
| Unit Cell, Å, ° | a = 17.648(3) | a = 17.724(1) | a = 17.812(2) | a = 10.2617(6) | a = 21.867(2) |
| | b = 10.0561(14) | b = 10.0664(6) | b = 10.098(1) | b = 13.4198(8) | b = 10.3085(9) |
| | c = 13.1714(19) | c = 13.1965(7) | c = 13.109(2) | c = 21.411(1) | c = 26.780(2) |
| | β = 112.531(2) | β = 112.067(1) | β = 112.733(2) | α = 72.738(1) | β = 108.787(1) |
| | | | | β = 85.591(1) | |
| | | | | γ = 83.501(1) | |
| Volume, Å³ | 2159.1(5) | 2182.0(2) | 2174.7(5) | 2794.7(3) | 5714.8(9) |
| Z | 2 | 2 | 2 | 2 | 4 |
| T, ° C. | −102 | −102 | −102 | −102 | −102 |
| λ, Å | 0.71073 | 0.71073 | 0.71073 | 0.71073 | 0.71073 |
| Calc. Density, | 3.557 | 2.853 | 2.428 | 2.168 | 2.509 |
| M | 21.217 | 7.718 | 2.760 | 2.179 | 5.931 |
| R^{a} | 0.0588 | 0.0307 | 0.0484 | 0.0583 | 0.0574 |
| wR₂^{b} | 0.1764 | 0.0826 | 0.1338 | 0.1927 | 0.1676 |

¹⁷O NMR spectra were collected on Bruker AM 300 spectrometer. The offset frequency was 40.687 MHZ, bandwidth was 50 KHz, and repetition rate was 10 Hz. All spectra were collected in deuterated water, except for the spectra of Re(CO)₅Br, Re(CO)₃(CH₃CN)₃CIO₄, Mn(CO)₃(CH₃CN)₃CIO₄ which were collected in deuterated acetonitrile. Collection time for unenriched samples was about 20 h.

IR spectra were obtained on Nicolet 7000 spectrometer with resolution of 2 cm⁻¹. All samples were prepared as KBr pellets.

TGA curves were obtained on TGA 2050 analyzer made by TA Instruments from room temperature to 950° C. under nitrogen atmosphere. Alumina pans were used for all measurements.

DSC curves were obtained on DSC 2910 calorimeter made by TA Instruments from room temperature to 725° C. under nitrogen atmosphere. Platinum pans were used for all measurements.

Cyclic voltammetry curves were obtained for all compounds in aqueous solution. 0.1 g of the corresponding compound was dissolved in 10 mL of deaerated water forming ˜0.02 M solution. 0.1 M Na(CH₃COO) was used as a supporting electrolyte. Platinum wire was used as a counting electrode, glassy carbon was used as a working electrode, and Ag/AgCl saturated electrode was used as a reference electrode.

Chemical analyses were performed by Kanti Technologies Inc., 43 Old Falls Blvd., N. Tonawanda, N.Y. 14120.

### Example XI

Selective Sequestration of Ln³⁺/An⁴⁺by [NaP₅W₃₀O₁₁₀]¹⁴⁻

The sodium cation that occupies the central cavity of this doughnut-shaped polyoxotungstate can be replaced only by cations of the same size, i.e. Ln³⁺, An⁴⁺(U-CM), Ca²⁺. Other cations are excluded. In aqueous solution (neutral or mildly acidic) at 160° C., Nd³⁺ for example is incorporated in the presence of the major components of tank wastes, i.e. a 200-fold molar excess of Na⁺, and in the presence of Fe³⁺ and Al³⁺. The encrypted metal cations are released by hydrothermal treatment under strongly acidic conditions.

### Example XII

Polytungstate Complexation of UO₂²⁺

Uranyl (and other actinyl) cations are stable in aqueous solution under normal atmospheric conditions. The first examples of polytungstate complexes of UO₂²⁺ have been synthesized and structurally characterized. Examples include [Na₂(UO₂)₂(PW₉O₃₄)₂]¹²⁻ and [(UO₂)₃(H₂O)₆As₃W₃₀O₁₀₅]¹⁵⁻. Anion [Na₂(UO₂)₂(PW₉O₃₄)₂]¹²⁻is formed in solutions of high [Na⁺] and is extract organic solvents.

### Example XIII

Conversion of Tungstolanthanide and -Actinide Salts into Tungsten Bronzes

Under relatively mild conditions (N₂ or H₂ atmosphere, 500-700° C.) ammonium salts of anions such as [(UO₂)₃(H₂O)₆As₃W₃₀O₁₀₅]¹⁵⁻ are cleanly converted into the cubic bronzes (Ln/An)ₓ,WO₃. This method of synthesis represents a major improvement over conventional methods (ground mixtures of oxides and tungsten powder, 1 000° C.). The chemical stability of the bronzes as candidates for potential waste forms is currently under investigation.

### Example XIV

Technetium Recovery and Storage

Initial investigations were carried out with rhenium as a Tc-surrogate. Tungstorhenates incorporating Re(V) Re(IV) have been characterized but polyniobates and niobotungstates offer the advantages of stability in alkaline solutions which constitute the majority of tank wastes. The example of a nioborhenate (IV) complex, [Re(Nb₆O₁₉)₂]¹²⁻ has been isolated from alkaline solution but has proved difficult to crystallize for structural confirmation. Furthermore, Re is slowly oxidized and released from this material. A much more promising strategy has recently been discovered. Alkaline (pH˜12) aqueous solutions of Nb₆O₁₉⁸⁻ react with Re(I) carbonyl complexes under hydrothermal conditions to form [Nb₆O₁₉Re(CO)₃]⁷⁻(V) and [Nb₆O₁₉{Re(CO₃}₂]⁶⁻ (syn and anti isomers, VI). The new complexes have been characterized by ¹⁷O NMR spectroscopy and single crystal X-ray structural analysis. The solid salts are thermally stable to 400° C. (loss of CO, not Re) and are inert to oxidation. Known synthetic routes to M¹ precursor species such as M(CO)₃⁺ from Re(Rc)O₄⁻, and the variety of nucleophilic polyoxometalate anions available, suggest that complexes such as V and VI will prove to be excellent vehicles for separation and storage of Tc wastes.

While the invention has been described in terms of preferred embodiments, the skilled artisan will appreciate that various modifications, substitutions, omissions and changes may be made without departing from the spirit thereof. Accordingly, it is intended that the scope of the present invention be limited solely by the scope of the following claims, including equivalents thereof.

What is claimed is:

1. A tricarbonyl metal derivative of a hexametalate anion or a salt thereof, wherein the derivative is of the formula [M₆O₁₉{M′(CO)₃}ₙ]⁽⁸⁻ⁿ⁾⁻, wherein M is Nb or Ta, M′ is Mn or Re and n is 1, 2, 3 or 4.

2. The tricarbonyl metal derivative of claim 1, wherein n is 1 or 2.

3. The tricarbonyl metal derivative of claim 1, wherein the derivative is stable in solution at a pH of about 4 or greater.

4. A tricarbonyl metal derivative or a salt thereof, wherein the tricarbonyl derivative is selected from the group consisting of:
[Re(CO)₃Nb₆O₁₉]⁷⁻; [Re(CO)₃Ta₆O₁₉]⁷⁻; [Mn(CO)₃Ta₆O₁₉]⁷⁻; [Mn(CO)₃Nb₆O₁₉]⁷⁻;trans-[{Mn(CO)₃}₂Nb₆O ₁₉]⁶⁻; cis-[{Mn(CO)₃}₂Nb₆O₁₉]⁶⁻; trans-[{Mn(CO)₃}₂Ta₆O₁₉]⁶⁻; cis-[{Mn(CO)₃}₂Ta₆O₁₉]⁶⁻; cis-[{Re(CO)₃}₂Nb₆O₁₉]⁶⁻; trans-[{Re(CO)₃}₂Nb₆O₁₉]⁶⁻; trans-[{Re(CO)₃}₂Ta₆O₁₉]⁶⁻; cis-[{Re(CO)₃}₂Ta₆O₁₉]⁶⁻.

5. A method for immobilizing technetium (Tc) which comprises binding Tc cations to a nucleophilic polyoxometalate anion, wherein Tc is stabilized by pi-acceptor through ion exchange of Re or Mn, initially present in the polyoxometalate anion.

6. The method of claim 5, wherein the polyoxometalate anion comprises a tricarbonyl metal derivative of a hexametalate of the formula [M₆O₁₉{M′(CO)_{3}n]}⁽⁸⁻ⁿ⁾⁻, wherein M is Nb or Ta, M′ is Mn or Re and n is 1, 2, 3 or 4.

7. The method of claim 6, wherein n is 1 or 2.

8. The method of claim 6, wherein the derivative is stable in solution at a pH of about 4 or greater.

9. The method of claim 6, wherein the tricarbonyl derivative is selected from the group consisting of:
[Re(CO)₃Nb₆O₁₉]⁷⁻; [Re(CO)₃Ta₆O₁₉]⁷⁻; [Mn(CO)₃Ta₆O₁₉]⁷⁻; [Mn(CO)₃Nb₆O₁₉]⁷⁻;trans-[{Mn(CO)₃}₂Nb₆O ₁₉]⁶⁻; cis-[{Mn(CO)₃}₂Nb₆O₁₉]⁶⁻; trans-[{Mn(CO)₃}₂Ta₆O₁₉]⁶⁻; cis-[{Mn(CO)₃}₂Ta₆O₁₉]⁶⁻; cis-[{Re(CO)₃}₂Nb₆O₁₉]⁶⁻; trans-[{Re(CO)₃}₂Nb₆O₁₉]⁶⁻; trans-[{Re(CO)₃}₂Ta₆O₁₉]⁶⁻; cis-[{Re(CO)₃}₂Ta₆O₁₉]⁶⁻.

10. A method for removing technetium from a composition comprising reacting a technetium containing composition which has been stabilized by attachment to a pi-acceptor ligand with a polyoxometalate anion to produce an insoluble technetium polyoxometalate product, and removing said insoluble technetium polyoxometalate product therefrom.

11. The method of claim 10, wherein said pi-acceptor ligand is CO or isonitrile.

12. The method of claim 10, wherein the polyoxometalate anion comprises at least one of Nb(V), Ta(V), Mo(VI), W(VI), W(IV), Ti(IV) and Zr(IV).

13. The method of claim 10, wherein said polyoxometalate anion comprises [Nb₆O₁₉]⁸⁻ or KMo₅O₁₆H(H₂O)_{∞.}

14. The method of claim 10, wherein the technetium material reacted with the polyoxometalate anion is [Tc(CO)₃(H₂O)₃]⁺, [Tc(NCR)₆]⁺, or (C₅Me₅)Tc(CO)₃.

15. The method of claim 10, wherein said reaction is effected under alkaline conditions.

16. The method of claim 10, wherein alkaline conditions comprise a pH about 12.

17. A method for immobilizing technetium (Tc) which comprises binding Tc cations, stabilized by pi-acceptor ligands, to highly nucleophilic polyoxometalate anions.

18. The method of claim 17, wherein the Tc cations are supplied by [Tc(CO)₃(H₂O)₃]⁺, [Tc(NCR)₆]⁺, (C₅Me₅)Tc(CO)₃ or Tc(CO)₅Br.

19. The method of claim 17, wherein the polyoxometalate anions contain an early transition element selected from the group consisting of Nb(V), Ta(V), Mo(VI), W(VI), W(IV), Ti(IV) and Zr(IV).

20. The method of claim 17, wherein the pi-acceptor ligand is CO.

21. A storage stable technetium (Tc) containing complex which comprises a pi-acceptor ligand stabilized Tc cation attached to a nucleophilic polyoxometalate anion or polymer containing.

22. The example of claim 21, wherein said pi-acceptor ligand is CO or isonitrile.

23. The complex of claim 21, wherein the polyoxoanion comprises Nv (V), Tc (V), Mo (VI), W (VI), W (IV), Ti (IV), Zr (IV), or a mixture thereof.

24. The complex of claim 21, which comprises [Tc(CO)₃(H₂O)₃]⁺, [Tc(NCR)₆]⁺, (C₅Me₅)Tc(CO)₃ or Tc(CO)₅Br.

25. The complex of claim 21, wherein the polyoxometalate anion comprises [Nb₆O]₁₉8− or KMo₅O₁₆H(H₂O)₂₈.
